(19) United States
(12) Patent Application Publication
(10) Pub. No.: US 2008/0002401 A1
(43) Pub. Date: Jan. 3, 2008

(54) Lamp conversion assembly

(76) Inventor: Phile Yang, Kaohsiung (TW)

Correspondence Address: Rabin & Berdo, P.C., Suite 500, 1101 14th Street, Washington, DC, 20005, US

(21) Appl. No.: 11/476,589

(22) Filed: Jun. 29, 2006

(51) Int. Cl. F21S 4/00

(52) U.S. Cl. 362/217

(57) ABSTRACT

A lamp conversion assembly has a lamp base and two adapters. The lamp base has two sockets each having two pin holes spaced at an interval. The adapters are attached respectively to the sockets and each has a housing, two conversion pins mounted respectively through the pin holes of the socket and two conducting member mounted in the housing and connected electrically to the conversion pins. The housing has two front pin holes spaced at an interval shorter than that between the pin holes and a gateway communicating with the front pin holes. The gateway of the adapter allows two pins of a T5 fluorescent tube to move through and be held in the front pin holes, which makes the T5 fluorescent tube capable of conveniently fitting with the T8 lamp.

### BACKGROUND OF THE INVENTION

1. Field of the Invention

The present invention relates to a lamp conversion assembly, and more particularly to a lamp conversion assembly which allows a shorter fluorescent tube to be mounted on an existing lamp base of a longer fluorescent tube.

2. Description of the Related Art

T8 fluorescent tubes have been commonly and extensively used but are gradually substituted by T5 fluorescent tubes which needs less electricity than T8 fluorescent tubes but generates more luminance. With higher lighting efficiency, T5 fluorescent tubes are in the place of T8 fluorescent tubes to reduce electricity consumption. However, A T5 fluorescent tube with a specific power value is shorter than a T8 fluorescent tube with the same power value, so that the T5 fluorescent tube is unable to be directly mounted on a lamp base for the T8 fluorescent tube. Therefore, and a specific lamp base for a T5 fluorescent tube is necessary, and this is inconvenient and uneconomical.

### SUMMARY OF THE INVENTION

The primary objective of the present invention is to provide a lamp conversion assembly to allow a T5 fluorescent tube to be conveniently and economically used and mounted on a T8 lamp base.

The lamp conversion assembly in accordance with the present comprises a lamp base and two adapters.

The lamp base may be a T8 lamp base and has an elongated body and two sockets. The elongated body has a top surface and two ends. The sockets are mounted respectively on the top surface of the elongated body near the two ends of the elongated body. Each of the sockets has a front surface, two pin holes defined in the front surface of the socket at an interval and a power circuit connected to a power system.

The adapters are mounted on the elongated body of the lamp base, attached detachably and respectively to the front surfaces of the sockets and each of the adapters has a housing, two conversion pins and two conducting member.

The housing is mounted on the elongated body of the lamp base, attached detachably to the front surface of the socket and has a front, a rear, a top, two front pin holes, two rear pin holes and a gateway. The front pin holes are defined through the front of the housing at an interval shorter than the interval between the pin holes of the socket for receiving two pins of a T5 fluorescent tube. The rear pin holes are defined through the rear of the housing and correspond respectively to the pin holes of the socket. The gateway is defined through the top of the housing and communicates with the front of the housing and the front pin holes of the housing to allow the pins of the T5 fluorescent tube to pass through and rotate a certain angle to be held in the front pin holes of the housing.

The conversion pins are mounted respectively through the rear pin holes of the housing and the pin holes of the socket in turn and are connected electrically to the power circuit of the socket.

The conducting members are mounted in the housing, are insulated to each other and are connected electrically and respectively to the conversion pins for supplying electricity to the T5 fluorescent tube.

With the adapters mounted on the lamp base, the T5 fluorescent tube is capable of fitting with a T8 lamp base directly and an additional T8 lamp base is unnecessary.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a lamp conversion assembly in accordance with the present invention;

FIG. 2 is a perspective view of the lamp conversion assembly in FIG. 1;

FIG. 3 is a side view of the lamp conversion assembly in FIG. 1;

FIG. 4 is an operational front view in partial section of the lamp conversion assembly in FIG. 1;

FIG. 5 is an operational side view in partial section of the lamp conversion assembly along line 5-5 in FIG. 4;

FIG. 6 is a front view in partial section of the lamp conversion assembly in FIG. 1;

FIG. 7 is a side view in partial section of the lamp conversion assembly along line 7-7 in FIG. 6;

FIG. 8 is an exploded perspective view of a second embodiment of the lamp conversion assembly in accordance with the present invention;

FIG. 9 is a perspective view of the lamp conversion assembly in FIG. 8;

FIG. 10 is a side view of the lamp conversion assembly in FIG. 8;

FIG. 11 is a front view in partial section of the lamp conversion assembly in FIG. 8;

FIG. 12 is a side view in partial section of the lamp conversion assembly along line 12-12 in FIG. 11;

FIG. 13 is an exploded perspective view of a third embodiment of the lamp conversion assembly in accordance with the present;

FIG. 14 is an exploded perspective view of a forth embodiment of the lamp conversion assembly in accordance with the present;

FIG. 15 is operational front view in partial section of the lamp conversion assembly in FIG. 13; and

FIG. 16 is operational front view in partial section of the lamp conversion assembly in FIG. 14.

### DETAILED DESCRIPTION OF THE PREFERRED EMBODIMENT

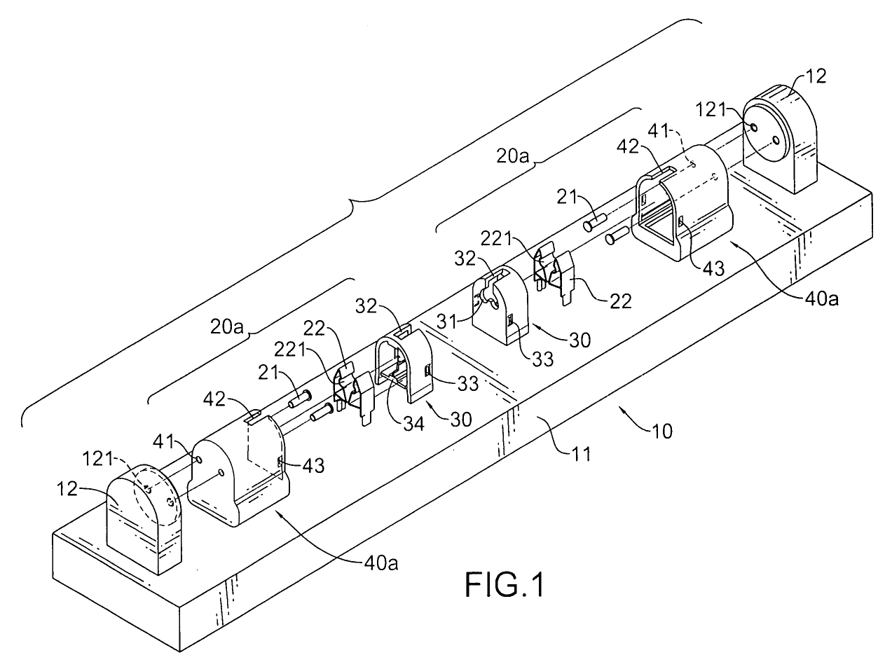

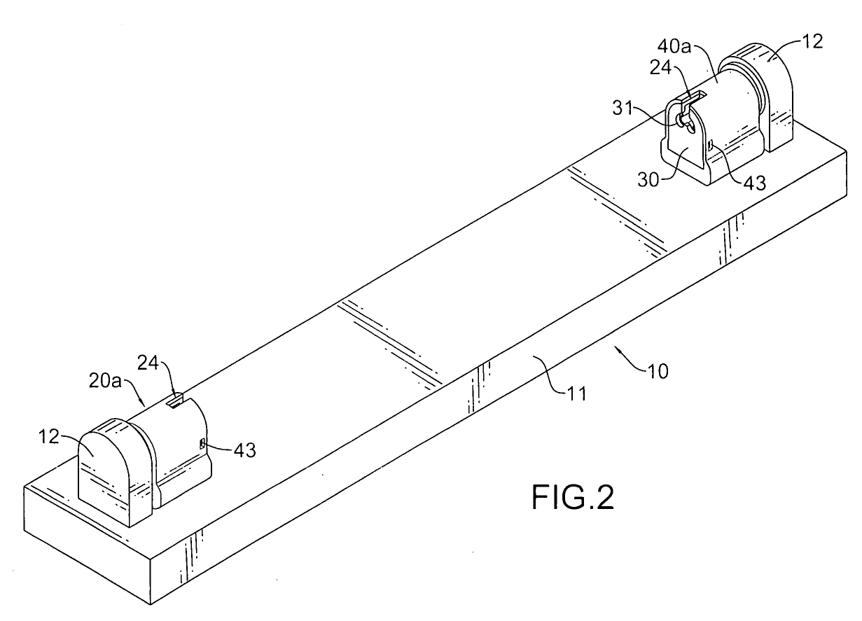

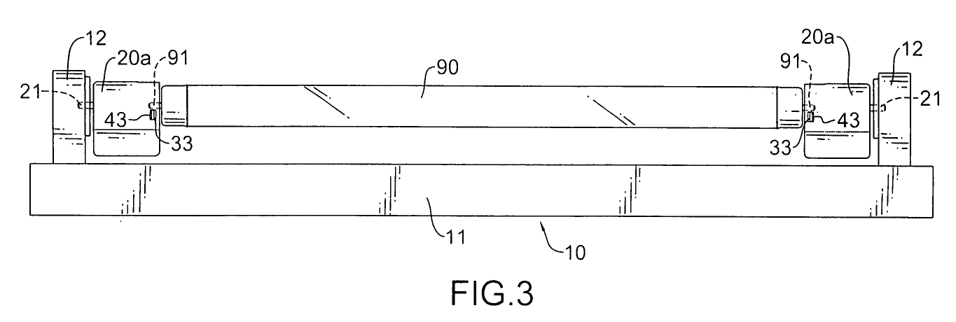

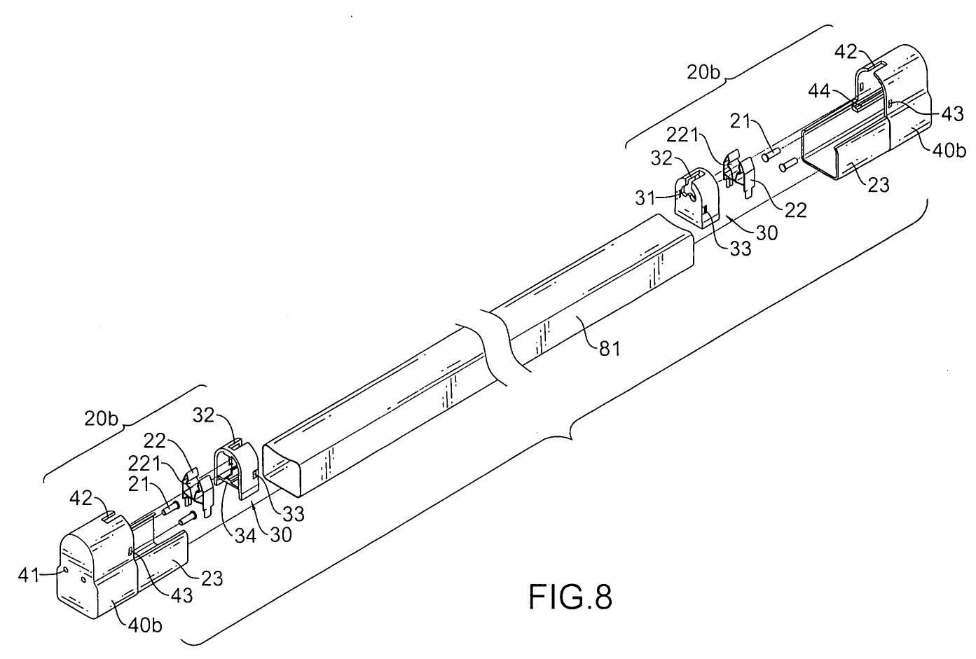

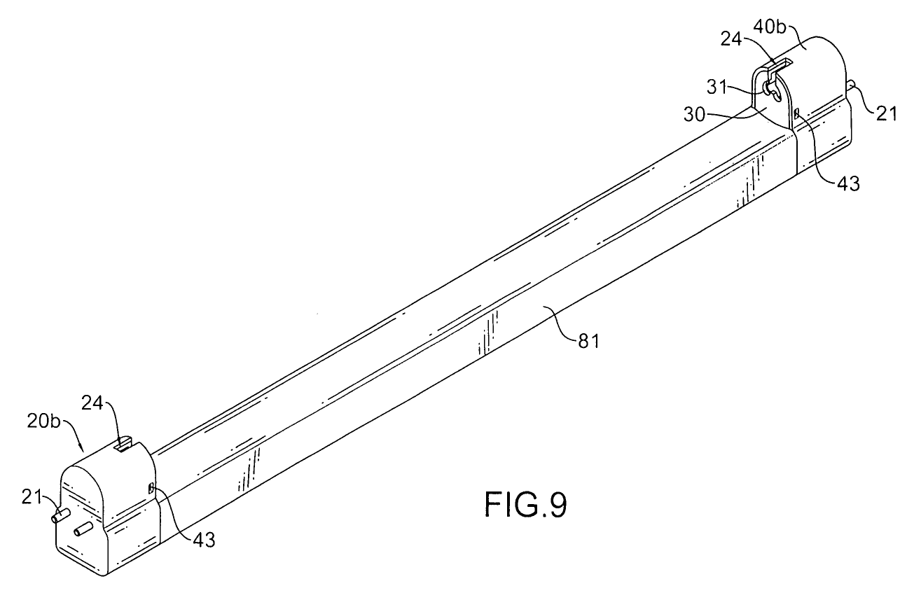

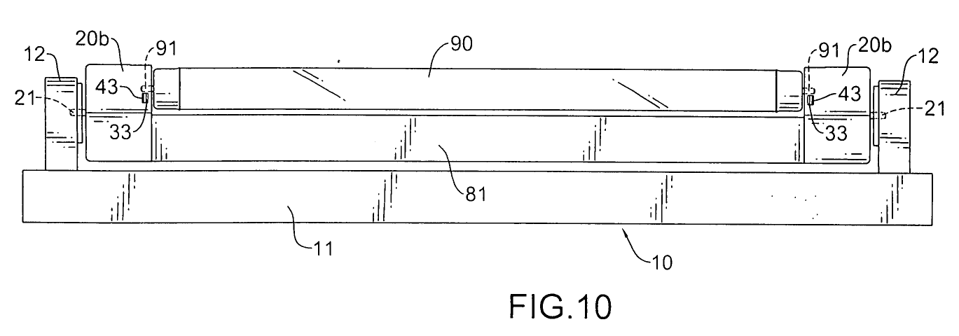

With reference to FIGS. 1-3 and 8-10, a lamp conversion assembly in accordance with the present invention comprises a lamp base (10), two adapters (20a, 20b), an optional adapter base (81) and two optional decorative covers (70a, 70b).

The lamp base (10) may be a lamp base for a T8 fluorescent tube and has an elongated body (11) and two sockets (12). The elongated body (11) has a top surface and two ends. The sockets (12) are mounted respectively on the top surface of the elongated body (11) near the two ends of the elongated body (11) and each of the sockets (12) has a front surface, a rear surface, a power circuit and two pin holes (121). The power circuit is connected to an external power source. The pin holes (121) are defined in the front surface of the socket (12) at a specific interval.

The adapters (20a, 20b) are mounted on the elongated body (11) of the lamp base (10) and are attached detachably and respectively to the front surfaces of the sockets (12). Each of the adapters (20a, 20b) has a housing, two conversion pins (21), two conducting members (22) and an optional connecting arm (23).

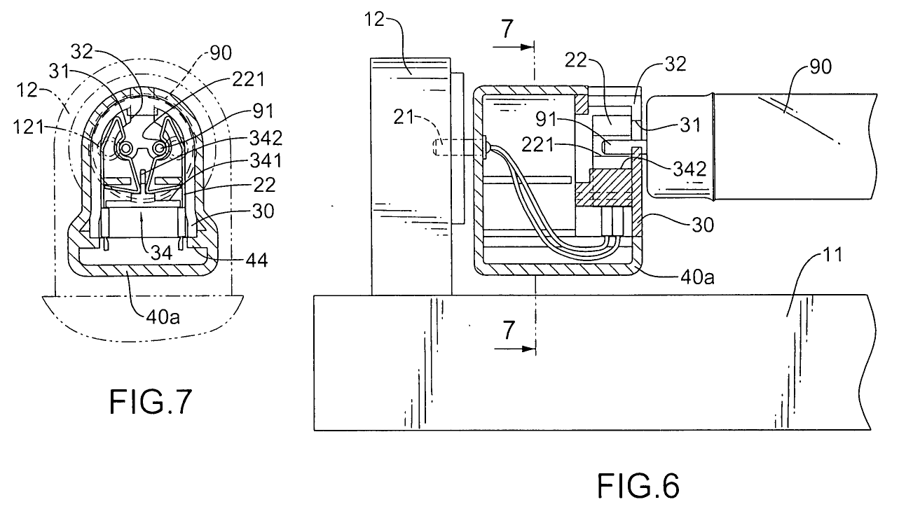

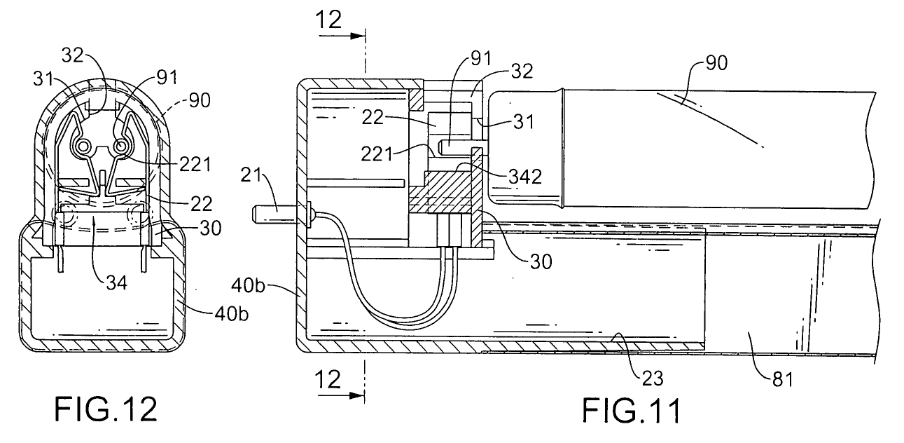

With further reference to FIGS. 6-7 and 11-12, the housing is mounted on the elongated body (11) of the lamp base (10), is attached detachably to the front surface of the socket (12), has a front, a rear, a top, two front pin holes (31), two rear pin holes (41), a gateway (24) and may include a major cap (40a, 40b) and a minor cap (30). The front pin holes (31) are defined through the front of the housing at a specific interval shorter than the specific interval between the pin holes (121) of the socket (12) for receiving two pins (91) of a T5 fluorescent tube (90). The rear pin holes (41) are defined through the rear of the housing and correspond respectively to the pin holes (121) of the socket (12).

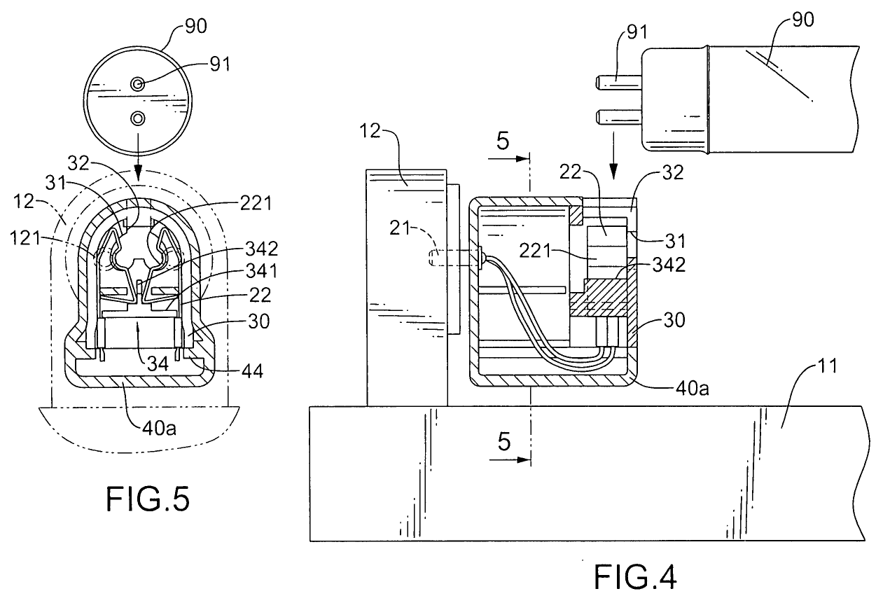

Wither further reference to FIGS. 4 and 5, the gateway (24) is defined through the top of the housing and communicates with the front of the housing and the front pin holes (31) of the housing to allow the pins (91) of the T5 fluorescent tube (90) to pass through the gateway (24) and to be held in the front pin holes (31) after rotating a certain angle.

The major cap (40a, 40b) is mounted on the elongated body (11) of the lamp base (10), is attached detachably to the front surface of the socket (12) and has an open front, a rear, a top, two sides, the two rear pin holes (41), a slot (42), multiple optional detents (43) and two optional guide rails (44). The open front of the major cap (40a, 40b) has a lower section. The rear of the major cap (40a, 40b) is the rear of the housing. The top of the major cap (40a, 40b) is part of the top of the housing. The rear pin holes (41) are defined through the rear of the major cap (40a, 40b). The slot (42) is defined through the top of the major cap (40a, 40b), communicates with the open front of the major cap (40a, 40b) and is part of the gateway (24) of the housing. The detents (43) are defined through the two sides of the major cap (40a, 40b) near the open front of the major cap (40a, 40b). The guild rails (44) are formed respectively and longitudinally on the two sides of the major cap (40a, 40b) inside the major cap (40a, 40b) below the detents (43) of the major cap (40a, 40b).

The minor cap (30) is mounted in the open front of the major cap (40a, 40b) and has an open rear, a front, a top, a bottom, two sides, the two front pin holes (31), a slot (32), multiple optional bosses (33) and an optional T-shape rib (34). The front of the minor cap (30) is the front of the housing. The top of the minor cap (30) is part of the top of the housing. The bottom of the minor cap (30) is mounted on the guide rails (44) of the major cap (40a, 40b). The front pin holes (31) are defined through the front of the minor cap (30). The slot (32) is defined through the top of the minor cap (30), corresponds to the slot (42) of the major cap (40a, 40b), communicates with the front of the minor cap (30) and the front pin holes (31) of the minor cap (30) and is part of the gateway (24) of the housing. The bosses (33) are formed on the two sides of the minor cap (30) and respectively correspond to and engage with the detents (43) of the major cap (40a, 40b). The T-shape rib (34) is formed longitudinally on the front of the minor cap (30) inside the minor cap (30) and has two transverse wings (341) and a partition (342) formed between the transverse wings (341).

The conversion pins (21) are mounted respectively through the rear pin holes (41) of the housing and the pin holes (121) of the socket (12) in turn, are connected electrically to the power circuit of the socket (12) and may be mounted respectively through the rear pin holes (41) of the major cap (40a, 40b).

The conducting members (22) are mounted in the housing, are connected electrically and respectively to the conversion pins (21), are insulated to each other and may be mounted on the T-shape rib (34) of the minor cap (30) and be separated by the partition (342) of the T-shape rib (34) inside the minor cap (30) for connecting electrically between the pins (91) of the T5 fluorescent tube (90) and the conversion pins (21). Each of the conducting members (22) may have an arc portion (221) conformed to one of the front pin holes (31) of the minor cap (30) for holding the pin (91) of the T5 fluorescent tube (90) securely.

The connecting arm (23) is formed on and extends longitudinally from the lower section of the open front of the major cap (40b).

The adapter base (81) is elongated and hollow, is mounted on the elongated body (11) of the lamp base (10) and has two open ends. The open ends of the adapter base (81) respectively receive the connecting arms (23) of the adapters (20b).

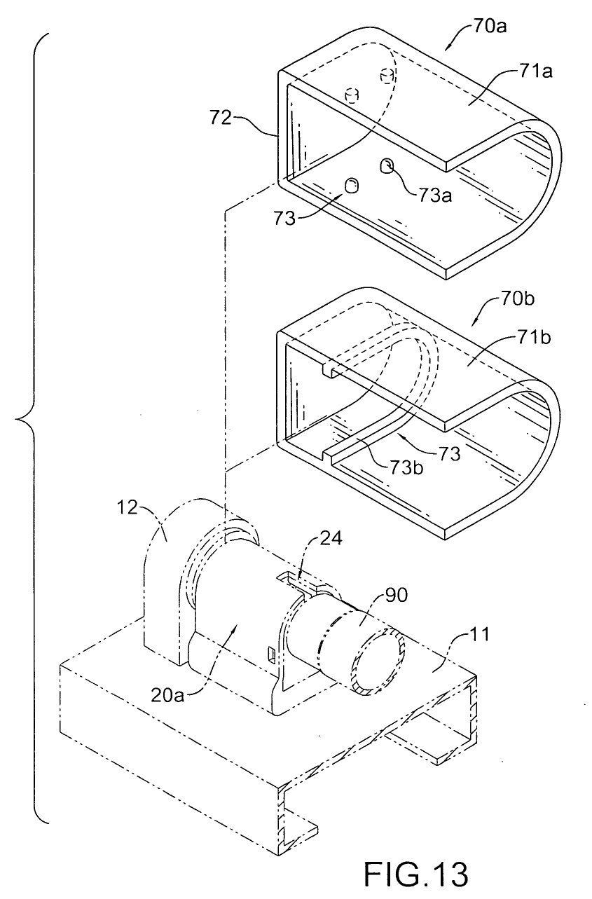

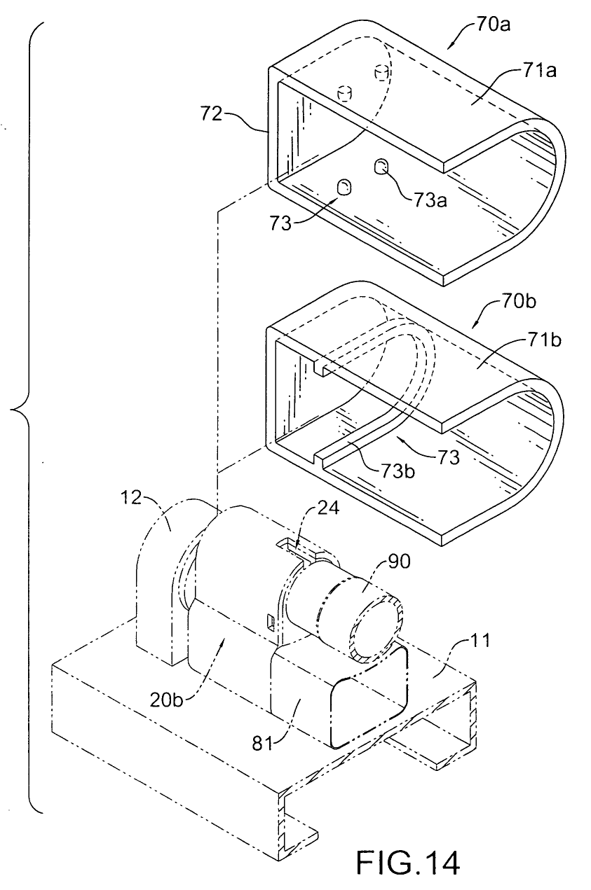

With further reference to FIGS. 13 and 14, the decorative covers (70a, 70b) are mounted detachably and respectively on the sockets (12) of the lamp base (10) and each has a cover body (71a, 71b) and a rear panel (72). The cover body (71a, 71b) is U-shape, is mounted around the socket (12), extends laterally to cover the housing of the adapter (20a, 20b) for making an appearance of the lamp conversion assembly neat and has a front end, a rear end, an inner wall, and a retainer (73). The retainer (73) is formed on and protrudes from the inner wall of the cover body (71a, 71b), abuts against the front surface of the socket (12) and may be multiple nubs (73a) or a U-shape rib (73b).

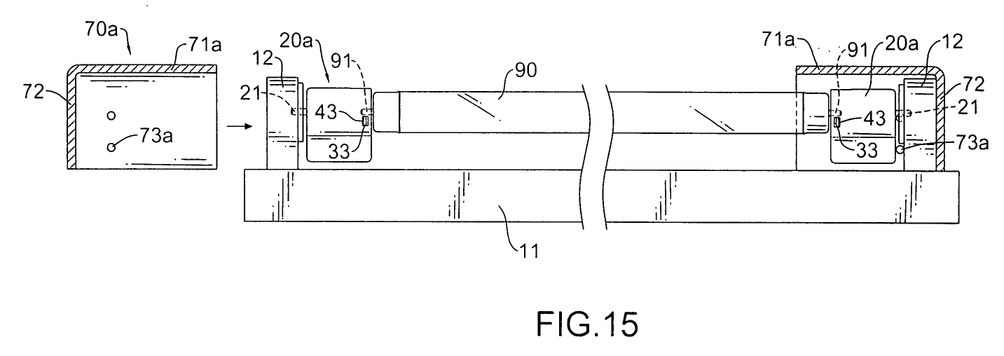

Wither further reference to FIG. 15, the multiple nubs (73a) are forced to abut against the front surface of the socket (12) by pushing the decorative cover (70a) from outside of the socket (12) or by pushing the decorative cover (70a) from topside of the socket (12).

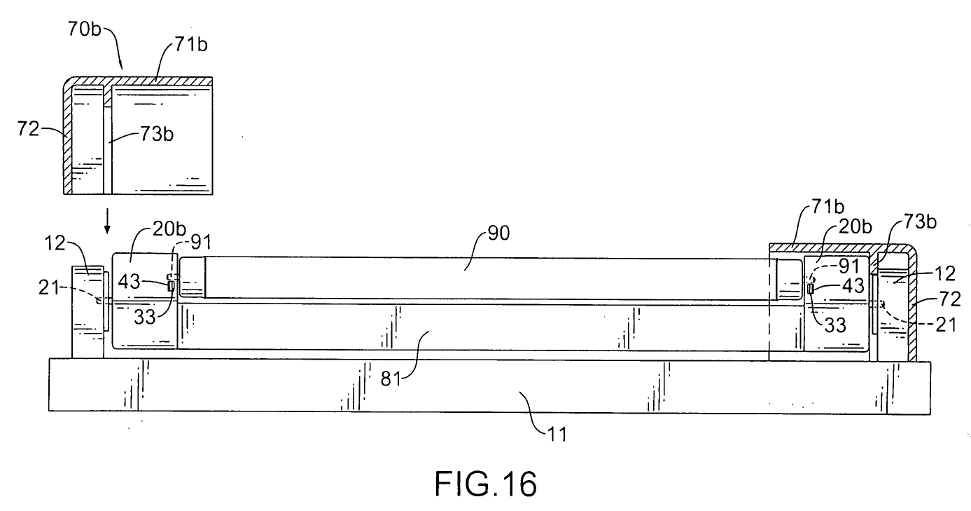

With further reference to FIG. 16, the U-shape flange (73b) is forced to abut against the front surface of the socket (12) by pushing the decorative cover (70b) from topside of the socket (12).

The rear panel (72) is formed on the rear end of the cover body (71a, 71b), abuts against the rear surface of the socket (12) such that the decorative cover (70a, 70b) is capable of holding the socket (12) between the retainer (73) and the rear panel (72).

The adapters (20a, 20b) are respectively attached to the sockets (12) of the lamp base (10) which may be a T8 lamp base to receive the pins (91) of a T5 fluorescent tube (90). Accordingly, the T5 fluorescent tube (90) is capable of fitting with a T8 lamp base and an additional T8 lamp base is unnecessary, and this is conveniently and economical.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A lamp conversion assembly comprising:
a lamp base having
an elongated body having a top surface and two ends; and
two sockets mounted respectively on the top surface of the elongated body near the two ends of the elongated body and each of the sockets having
a front surface;
a rear surface; and
two pin holes defined in the front surface of the socket at an interval; and
two adapters mounted on the elongated body of the lamp base, attached detachably and respectively to the front surfaces of the sockets and each of the adapters having
a housing mounted on the elongated body of the lamp base, attached detachably to the front surface of a corresponding one of the sockets and having
a front;
a rear;
a top;
two front pin holes defined through the front of the housing at an interval shorter than the interval between the pin holes in the corresponding socket;
two rear pin holes defined through the rear of the housing and corresponding respectively to the pin holes in the corresponding socket; and
a gateway defined through the top of the housing and communicating with the front of the housing and the front pin holes of the housing;
two conversion pins mounted respectively through the rear pin holes of the housing and the pin holes of the corresponding socket in turn; and
two conducting members mounted in the housing, insulated to each other and connected electrically and respectively to the conversion pins.

2. The lamp conversion assembly as claimed in claim 1, wherein the lamp conversion assembly further comprises
two decorative covers mounted detachably and respectively on the sockets of the lamp base and each having
a cover body being U-shape, mounted around a corresponding one of the sockets, extending laterally to cover the housing of a corresponding one of the adapters and having
a front end;
a rear end;
an inner wall; and
a retainer formed on and protruding from the inner wall of the cover body and abutting against the front surface of the corresponding socket; and
a rear panel formed on the rear end of the cover body and abutting against the rear surface of the corresponding socket.

3. The lamp conversion assembly as claimed in claim 1, wherein
the housing of each adapter includes
a major cap mounted on the elongated body of the lamp base, attached detachably to the front surface of a corresponding one of the sockets and having
an open front having a lower section;
a rear being the rear of the housing;
a top being part of the top of the housing;
two sides;
the two rear pin holes defined through the rear of the major cap; and
a slot defined through the top of the major cap, communicating with the open front of the major cap and being part of the gateway of the housing; and
a minor cap mounted in the open front of the major cap and having
an open rear;
a front being the front of the housing;
a top being part of the top of the housing;
a bottom;
two sides;
the two front pin holes defined through the front of the minor cap; and
a slot defined through the top of the minor cap, corresponding to the slot of the major cap, communicating with the front of the minor cap and the front pin holes of the minor cap and being part of the gateway of the housing; and
the conversion pins of each adapters are mounted respectively through the rear pin holes of a corresponding one of the major caps.

4. The lamp conversion assembly as claimed in claim 2, wherein the retainer of the cover body of each decorative cover comprises multiple nubs.

5. The lamp conversion assembly as claimed in claim 2, wherein the retainer of the cover body of each decorative cover comprises a U-shape rib.

6. The lamp conversion assembly as claimed in claim 3, wherein
each adapter further has a connecting arm formed on and extending longitudinally from the lower section of the open front of a corresponding one of the major caps; and
the lamp conversion assembly further comprises an adapter base being elongated and hollow, mounted on the elongated body of the lamp base and having
two open ends respectively receiving the connecting arms of the adapters.

7. The lamp conversion assembly as claimed in claim 3, wherein
the major cap of each adapter further has multiple detents defined through the two sides of the major cap near the open front of the major cap; and
the minor cap of each adapter further has multiple bosses formed on the two sides of the minor cap and respectively corresponding to and engaging with the detents of a corresponding major cap.

8. The lamp conversion assembly as claimed in claim 3, wherein
the minor cap of each adapter further has a T-shape rib formed longitudinally on the front of the minor cap inside the minor cap and having
two transverse wings; and
a partition formed between the transverse wings; and
the conducting members of each adapter is mounted on the T-shape rib of a corresponding minor cap and separated by the partition of the T-shape rib inside the corresponding minor cap.

9. The lamp conversion assembly as claimed in claim 7, wherein
the major cap of each adapter further has two guide rails formed respectively and longitudinally on the two sides of the major cap inside the major cap below the detents of the major cap; and
the bottom of the minor cap of each adapter is mounted on the guide rails of the corresponding major cap.

10. The lamp conversion assembly as claimed in claim 8, wherein
each of the conducting members of each adapter further has an arc portion conformed to one of the front pin holes of the minor cap of a corresponding adapter.
